(19) United States
(12) Patent Application Publication
(10) Pub. No.: US 2006/0286950 A1
(43) Pub. Date: Dec. 21, 2006

(54) Mobile radio receiver with improved real-time precision

(75) Inventor: Rolf Friedrich Philipp Becker, Adliswil (CH)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/533,728

(22) PCT Filed: Oct. 20, 2003
(86) PCT No.: PCT/IB03/04630

§ 371 Date: May 3, 2005

(30) Foreign Application Priority Data
Nov. 7, 2002 (EP) 02102547.3

(51) Int. Cl. H04B 1/18

(52) U.S. Cl. 455/171.1

(57) ABSTRACT

The invention relates to a mobile radio receiver comprising a receiving device (22, 19) for receiving time reference signals. In order to allow a precise real-time indication on mobile radios, a mobile radio is proposed comprising a GSM receiving unit (1) with a next-in-line analog-to-digital converter (3) for converting analog signals into digital signals, a digital signal processor (4) for reconstructing and processing the received signals, a system controller (5) for controlling the components of the mobile radio, a real-time circuit (7) comprising an oscillator (8) and a display (6) for showing information, in which mobile radio a further receiving unit (19, 22) is arranged for receiving a time reference signal, which further receiving unit (19, 22) comprises an antenna (18, 13) for receiving time reference signals, tunable capacitors (12) for being tuned to the transmit frequency and an amplifier (11) for amplifying the received time reference signal, and a multiplex unit (2) inserted between the GSM receiving unit 1) and the analog-to-digital converter (3), which multiplex unit (2) can be supplied with the received analog mobile radio signal and the time reference signal and in which mobile radio the received time reference signal can be applied at a predetermined instant to the digital signal processor DSP (4) for demodulation and filtering and to the system controller (5) for decoding, and there is provided to update the real-time circuit (7) with the decoded time reference signal. In this way a GSM mobile radio is obtained with little hardware or software supplements, which mobile radio is in a position to receive and decode a time reference signal and use the time reference signal for updating the real-time circuit (7).

The invention relates to a mobile radio receiver comprising a receiving device for receiving time reference signals, more particularly on a GSM mobile radio telephone.

Contemporary mobile radios have a great many additional features. For example, they may be used as an organizer, as an alarm clock or as a pocket calculator. In most cases the displays of the radios also show the date and the real time. The precision of the date and time displays is the object of the present invention. Mobile radios may for example also be arranged as an additional feature for notebooks in the form of a PC card.

Based on freewheeling oscillators which are used as a reference for the real-time circuit, there is often great imprecision when the real time is displayed. These free-wheeling oscillators have a limited precision and are sensitive to temperature variations and furthermore, their precision changes when the batteries are running low. The precision of all the clocks one has meanwhile grown accustomed to is thus lacking in the furthermore ultra modem and also reliably operating mobile radios. Furthermore, these free-wheeling oscillators cannot take for example the time change between summer and wintertime or between time zones into account.

In the widely used GSM standard for mobile radio no time information is co-transmitted, so that unlike CDMA or GPS signals the radio signal does not contain time information that is then only to be extracted.

Therefore, it is an object of the invention to provide an arrangement and a method with which a precise real time can be indicated.

This object is achieved by a mobile radio having a GSM receiving unit, a secondary analog-to-digital converter for converting analog signals into digital signals, a digital signal processor for reconstructing and processing the received signals, a system controller for controlling the components of the mobile radio, a real-time circuit with an oscillator and a display for displaying information, in which radio a further receiving unit is arranged for receiving a time reference signal, which unit comprises an antenna for receiving time reference signals, tunable capacitors for tuning to the transmit frequency and an amplifier for amplifying the received time reference signal, and a multiplex unit inserted between the GSM receiving unit and the analog-to-digital converter, to which multiplex unit the received analog mobile radio signal and the time reference signal can be applied and in which radio the received time reference signal can be applied to the digital signal processor at a predefined time for demodulation and filtering and to the system controller for decoding, and the real-time circuit is provided to be updated by the decoded time reference signal.

The invention is based on the recognition that a plurality of time reference signals are available which, however, have so far not been used by the mobile radios for precisely displaying the time.

Mobile radios typically include a GSM receiving unit which receives radio signals at a respective transmit frequency of about 900 MHz, 1800 or 1900 MHz. The GSM receiving unit transmits a baseband signal having a frequency range from about −130 kHz to +130 kHz to the secondary analog-to-digital converter.

In Germany the time reference signal DCF77 is transmitted at a transmit frequency of 77.5 kHz. This signal covers central Europe. A British time signal is transmitted at 60 kHz and covers Great Britain. Also in other parts of the world such time reference signals are available. These time reference signals are thus situated directly in the area covered by the components of mobile radios and can be processed by these components.

To be able to receive such a time reference signal, the mobile radios are equipped with a further receiving unit. This further receiving unit comprises an antenna which is suitable for receiving the time reference signals. This antenna can be set to the frequency of the respective time reference signal by means of a tunable capacitor. Furthermore, an amplifier is provided for amplifying the received time reference signal. This amplifier provides an amplification of the time reference signal up to a value that is suitable for further processing by the analog-to-digital converter arranged in the mobile radio. The time reference signal thus amplified is applied to a multiplexer to which also the baseband signal is applied. The multiplexer transfers the received mobile radio signal or the time reference signal, depending on the receiving state, to the downstream analog-to-digital converter. Following the analog-to-digital converter is a processor which is provided for processing digital signals. This processor is a digital signal processor (DSP) that comprises not only the processor but also integrated memories in which both the program for the filter etc. and the data for processing are stored. In this DSP the precise time reference signal can be extracted by a selective bandpass filter around the carrier frequency of the time signal if the digitized time reference signal is applied to the multiplexer and to the downstream DSP. In the DSP, filter programs and demodulation methods are implemented as programs. The filter for filtering the time reference signal is implemented as a software extension in the existing DSP. The received time reference signal is filtered by the DSP and demodulated and then transferred to the system controller for decoding. The system controller updates the connected time circuit with the decoded time signal, so that the display of time or date can thus permanently be updated.

In an advantageous embodiment of the invention the multiplexer and in the receiving unit the gain factor and the tunable capacitance are set or controlled respectively, by the system controller. The system controller thus determines when the mobile radio signal is transferred to the DSP and when the time reference signal is transferred and an update of the time indication is made. The multiplexer is controlled by the system controller so that the time reference signal is transferred only at certain times. Basically, the mobile radio signal is transferred. There may preferably be determined at what time distances the time circuit is to be updated. This may be determined, on the one hand, by the programming of the system controller, for example, at least once a day or always before the switching off or on switching on of the mobile radio, on the other hand, the user can also adapt the update time distance as a function of the imprecision of the time indication of the mobile radio. If the reception of the time reference signal is too weak, the system controller tries to readjust the frequency or set a predefined other frequency for the reception of the time reference signal. The system controller establishes whether a time reference signal becomes too weak and can then change the tunable capacitance by including or removing capacitors and make the reception of other time reference signals possible at other frequencies. Furthermore, there may be fixedly predefined at what times the time circuit is updated or the update time distance may be set by the user.

The object is achieved by a method in which for receiving a time reference signal and for updating a real-time circuit in a mobile radio, a GSM mobile radio signal is received by a GSM receiving unit and a time reference signal by a further receiving unit, while the time reference signal, once it has been amplified to a similar level to the mobile radio signal, is applied to a multiplex unit and is demodulated and filtered by a digital signal processor of the mobile radio and decoded by a system controller and the real-time circuit is updated with the decoded time information.

In an advantageous embodiment of the invention the time reference signal is an amplitude-modulated signal. Since then the time information is coded in the amplitude of the time reference signal, a simple power measurement will suffice to extract time and data from the time reference signal. This extraction may be achieved by a refinement of the programs running on the DSP. Also the power measurement and the extraction are carried out by the DSP, so that the programs need only be extended by these functions without additional hardware being necessary. The extracted time or date signal is decoded by a system controller and applied to the real-time circuit (RTC). The real-time circuit is updated with a decoded time or date signal.

In a further embodiment of the invention mobile radios are used in which an FM receiver has already been integrated. Many mobile radios already have an integrated FM receiver to be able to utilize the mobile radio also as a radio. In many FM signals RDS or RDBS information is contained. This RDS signal also contains time information. The RDS/RDBS information is transmitted at a transmit frequency of 57 kHz. Also this frequency fits in the frequency range that can be processed by the components of a mobile radio. In the embodiment according to the invention the received FM signal is applied to the multiplexer that is controlled by the system controller. When the FM signal is transferred, the DSP extracts, for example, also the RDS signal, so that the time reference signal thus obtained is used by the system controller for updating the real-time circuit. The demodulation of the RDS/RDBS signal is again carried out by the digital signal processor. Also the channel filtering is taken over by the DSP. The system controller then decodes the demodulated time reference signal from the RDS/RDBS signal and updates the real-time circuit.

In a further advantageous embodiment of the invention the digital signal processor can extract, besides the time reference signal, also the further information of the RDS/RDBS signal and show same on the display. For example, it is possible for the broadcasting radio station, title, singer or genre respectively, co-transmitted in the RDS/RDBS signal, to be shown on the display of the mobile radio when a radio station is listened to.

A further advantage of the invention becomes apparent when a switch is made to a different time reference signal. The change of the time reference signal does not require a change of time zones either. Also the change from summer to winter time is automatically detected.

This embodiment according to the invention of a mobile radio makes it possible to receive the available time reference signals via a further receiving unit. The further processing of the received time reference signal is carried out by the available components of the mobile radio, which only need to be complemented by the programs for filtering, measuring, extracting and decoding the time reference signal.

These and other aspects of the invention are apparent from and will be elucidated with reference to the embodiments described hereinafter.

In the drawings:

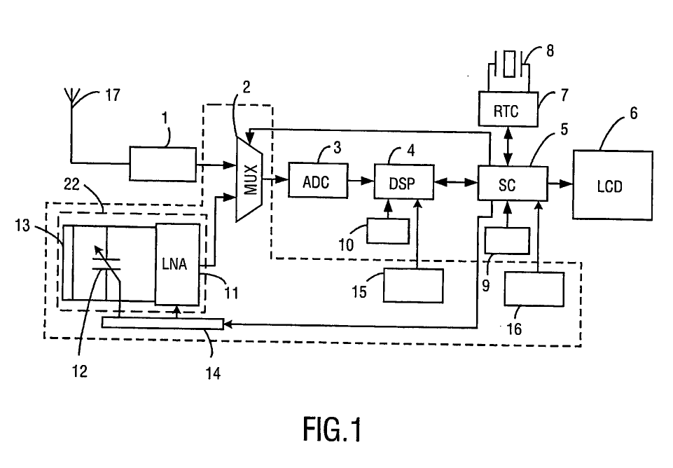

FIG. 1 shows a block circuit diagram of a mobile radio with an AM receiving unit for receiving a time reference signal; and

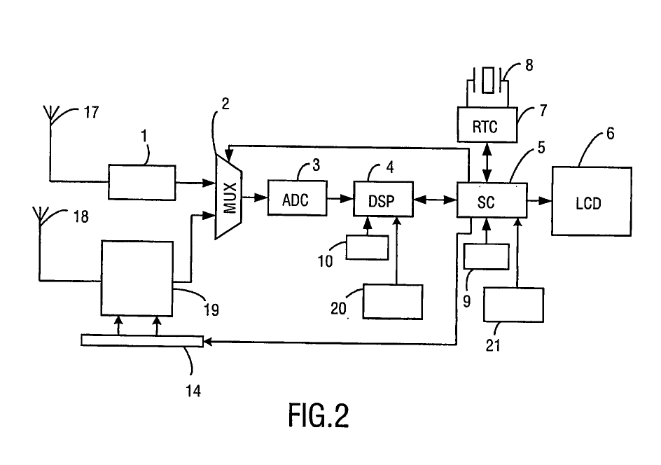

FIG. 2 shows a block circuit diagram of a mobile radio with an FM receiving unit.

FIG. 1 shows a mobile radio which comprises in addition to the GSM receiving unit I also a further AM receiving unit 22 for receiving a time reference signal.

This further receiving unit 22 comprises an antenna 13 for example in the form of a ferrite core, a tunable capacitor 12 and a preamplifier (LNA) 11. This AM receiving unit 22 is designed to receive time reference signals, for example, the DCF77 in the medium-wave frequency range (in the AM range). The time reference signal received is applied to the multiplexer 2 after an amplification in the preamplifier 11. Also the received analog mobile radio signal is applied to the multiplexer 2. The multiplexer 2 is controlled by the system controller 5, which means that the system controller 5 determines when the analog mobile radio signal and when the time reference signal is transferred to the analog-to-digital converter 3.

A respective transferred analog signal is converted into a digital signal by the analog-to-digital converter 3 and applied to the digital signal processor 4. The digital signal processor executes a channel filtering by means of a bandpass filter. The time information is amplitude-modulated, so that the DSP, after demodulation, needs to carry out only one more power measurement. The system controller 5 then decodes the time information and thus updates the real-time circuit 7. The display 6 shows the time and the date in addition to other information. Implemented software 10 and 9 is executed both on the DSP 4 and on the system controller 5, which software is also referred to as firmware. This firmware comprises the coefficients and programs for the filtering and the demodulation and decoding methods. This firmware or software 10 is only to be extended by a program for the channel filtering 15 and for the demodulation method 15. The programs for a channel filtering and also the demodulation method are known. The software 9 for the system controller 5 is to be extended by the decoding algorithm 16 for the time reference signal. Furthermore, in the system controller is to be implemented a control for the receiving unit 22. Both the tunable capacitor 12 and also the gain of the preamplifier 11 are set by the system controller 5 via an interface 14. The dashed line shows the components to be added. The mobile radio is to be extended by the AM receiving unit 22. Furthermore, software supplements 15, 16 for the DSP and the system controller are to be added. Thus, by simple supplements an exact real-time indication can be produced.

FIG. 2 shows a mobile radio comprising an FM receiving unit 19.

The FM signal is received via the antenna 18, which FM signal mostly also contains an RDS/RDBS signal. This FM signal is applied to the multiplexer 2. When the received FM station is listened to, the signal is filtered and demodulated by the DSP. Compared to the known versions, DSP is complemented by software 20 which makes a filtering and demodulation of the RDS signal possible. Also this software known. The decoding of the RDS signal is carried out by the system controller 5 which updates the real-time circuit 7 by means of the decoded time signal. As is shown in FIG. 1, the system controller also controls the reception of the FM signal via the interface 14. In this circuit only the software for the DSP and the system controller 5 is to be extended to extract the time information from the RDS signal.

1. A mobile radio comprising a GSM receiving unit (1), an analog-to-digital converter (3) next in line for converting analog signals into digital signals, a digital signal processor (4) for reconstructing and processing the received signals, a system controller (5) for controlling the components of the mobile radio, a real-time circuit (7) comprising an oscillator (8) and a display (6) for displaying information, in which a further receiving unit (19, 22) is arranged for receiving a time reference signal, which further receiving unit (19, 22) comprises an antenna (13, 18) for receiving time reference signals, tunable capacitors (12) for tuning to the transmit frequency and an amplifier (11) for amplifying the received time reference signal, and a multiplex unit (2) inserted between the GSM receiving unit (1) and the analog-to-digital converter (3), which multiplex unit (2) can be supplied with the received analog mobile radio signal and the time reference signal and in which mobile radio the received time reference signal can be applied at a predetermined instant to the digital signal processor (4) for demodulation and filtering and to the system controller (5) for decoding, and there is provided to update the real-time circuit (7) with the decoded time reference signal.

2. A mobile radio as claimed in claim 1, characterized in that the multiplex unit (2) can be controlled by the system controller (5).

3. A mobile radio as claimed in claim 1, characterized in that the gain factor of the amplifier (11) and the tunable capacitance (12) can be set by the system controller (5).

4. A mobile radio as claimed in claim 1, characterized in that the real-time circuit (7) can be updated by the system controller (5).

5. A mobile radio as claimed in claim 1, characterized in that the updating distance can be chosen at will or is fixedly programmed.

6. A mobile radio as claimed in claim 1, characterized in that the further receiving unit is a receiving unit (22) for amplitude-modulated signals.

7. A mobile radio as claimed in claim 1, characterized in that the receiving unit is a receiving unit (19) for frequency-modulated signals.

8. A method for receiving a time reference signal and updating a real-time circuit (7) in a mobile radio, in which a GSM mobile radio signal is received by a GSM receiving unit (1) and a time reference signal is received by a further receiving unit (22, 19), in which the time reference signal after being amplified to a similar level to the mobile radio signal is applied to a multiplex unit (2) and is demodulated and filtered by a digital signal processor (4) of the mobile radio and decoded by a system controller (5) and the real-time circuit (7) is updated with the decoded time information.

9. A method as claimed in claim 8, in which the time reference signal is an amplitude-modulated signal.

10. A method as claimed in claim 8, in which the time reference signal is contained in a frequency-modulated RDS/RDBS signal.

11. A method as claimed in claim 10, in which the other information contained in the RDS/RDBS signal is decoded and shown on the display.
